(19) United States
(12) Patent Application Publication
(10) Pub. No.: US 2008/0034096 A1
(43) Pub. Date: Feb. 7, 2008

(54) Method and Apparatus for Transferring Multimedia Signals from a Handheld Device to a Computer System for Display

(75) Inventors: Azzedine Tourzni, West Dundee, IL (US); Sasa Marinkovic, Toronto (CA); Wilson Kwan, Toronto (CA); Mark Bapst, South Barrington, IL (US); Milivoje Aleksic, Richmond Hill (CA); Kevin O'Neil, Toronto (CA)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 11/461,674

(22) Filed: Aug. 1, 2006

(51) Int. Cl. G09G 5/08; G06F 15/177; G06F 15/16

(52) U.S. Cl. 709/227; 345/158; 709/220; 709/246

(57) ABSTRACT

A demodulated multimedia signal is generated based on a captured handheld multimedia signal or a captured terrestrial multimedia signal where the handheld multimedia signal is formatted for reproduction on a handheld device and the terrestrial multimedia signal is formatted for reproduction on a computer system. The demodulated multimedia signal or a decoded multimedia signal (based on the demodulated multimedia signal) is transferred to a computer system for visual and/or audible reproduction on a computer system or for transmission to another computer system. The video information associated with the transferred signal is scaled by the computer system prior to display to match the display characteristics and capabilities of the computer system. The transferred signal may correspond to multiple channels of multimedia signals thereby enabling the display of multiple multimedia signals at the same time.

### FIELD OF THE INVENTION

The invention generally relates to receiving handheld multimedia signals and terrestrial multimedia signals and more particularly to the display of handheld multimedia signals and terrestrial multimedia signals.

### BACKGROUND OF THE INVENTION

Traditional computer systems such as laptop computers, desktop computers, high definition televisions and other non-mobile computing devices have transformed the modern world by providing users the ability to interact with a variety of multimedia content. For example, some subscriber services allow users to download on-line music videos (e.g., one type of multimedia content) over the internet After selection, the content arrives in a series of data packets representative of one or more multimedia signals Thereafter, the video information and audio information is parsed from the multimedia signals using known techniques and is subsequently decoded for visual reproduction on a display and audible reproduction on one or more speakers.

While the above discussion provides one example of multimedia content provided over the internet, it is recognized that multimedia content may be transmitted in a variety of formats and over a variety of media including radio frequency waves, wireless connections or buses (e.g., using Bluetooth, IEEE 802.11, etc.) and physical connections or buses (e.g., optical cable, copper telephone lines, etc.).

Similarly, handheld devices such as mobile phones, personal digital assistants (“PDAs”), portable audio players (e.g., the Apple iPod) and other mobile devices have transformed the modern world by providing many practical mobile services to users wherever they may travel. For example, many mobile phones are capable of much more than mere telephonic capabilities. Similar to “traditional” computer systems, mobile phones (which themselves are computer systems in their own right) are capable of rendering multimedia content to its users in the same manner as described above.

Because traditional computer systems are generally characterized as having superior processing power, more memory capacity and larger displays, and because handheld devices are battery operated, traditional computer systems are generally capable of supporting a wider variety of multimedia content than handheld devices. Consequently, multimedia signals may be formatted for the device on which video information and audio information will be played. Similarly, multimedia signals may also be formatted for the type of transmission media along which they will travel to their final destination. For example, digital television signals may be formatted according to the Digital Video Broadcasting suite of standards. The DVB suite comprises standards for the modulation/demodulation, compression/decompression and transmission of digital television signals by satellite (DVB-S and DVB-S2), cable (DVB-C), terrestrial television (DVB-T) and terrestrial television for handhelds (DVB-H). Compliance with the standards and with other standards and procedures may assist manufacturers in delivering multimedia content with a defined quality of service (QoS).

The inventors have recognized that although handheld users are capable of receiving, visually reproducing and audibly reproducing handheld multimedia signals formatted for handheld devices, a need exists for the transmission of handheld multimedia signals from a handheld device to a computer system. Similarly, a need exists for the reception, by a handheld device, of terrestrial multimedia signals designed for the visual reproduction and/or audible reproduction of underlying video information and audio information on a computer system such that the handheld device is further able to transfer the received terrestrial multimedia signals to the computer system. The computer system may be better suited to visually and audibly reproduce the underlying video and audio information and may further provide additional options that are not otherwise readily available to the user of a handheld device.

### BRIEF DESCRIPTION OF THE DRAWINGS

The invention will be more readily understood in view of the following description when accompanied by the below figures and wherein like reference numerals represent like elements:

FIG. 1 is a block diagram illustrating one example of a system including a handheld device coupled to at least one computer system via a connection in accordance with one embodiment of the present disclosure;

FIG. 2 is a block diagram illustrating one example of a computer system as illustrated in FIG. 1;

FIG. 3 is a flow chart illustrating one example of a method for transferring handheld multimedia signals for reproduction on a computer system or for transmission to another computer system in accordance with one embodiment of the present disclosure;

FIG. 4 is a flow chart illustrating one example of a method for determining which multimedia signals will be transferred to the computer system in accordance with one embodiment of the present disclosure;

FIG. 5 is a flow chart illustrating one example for generating at least one demodulated multimedia signal and providing additional transmission, reproduction and storage capabilities in accordance with one embodiment of the present disclosure;

FIG. 6 is a flow chart illustrating one example for reproducing or transferring received multimedia signals from a handheld device in accordance with one embodiment of the present disclosure;

FIG. 7 illustrates one example for generating a computer system-generated handheld decoded multimedia signal and a computer system-generated terrestrial decoded multimedia signal, and scaling decoded signals for visual display on computer system in accordance with one embodiment of the present disclosure; and

FIG. 8 illustrates one method of audibly reproducing, on at least one computer system speaker, audio information associated with the transferred signal, in accordance with one embodiment of the present disclosure.

### DETAILED DESCRIPTION

Generally, the present description provides a method and apparatus for generating a demodulated multimedia signal based on a captured handheld multimedia signal formatted for visual reproduction or audible reproduction on the handheld device; and subsequently transferring the demodulated multimedia signal or a decoded multimedia signal (based on the demodulated multimedia signal) to a computer system, external to the handheld device, for visual or audio reproduction thereon. Alternatively, the demodulated multimedia signal may be based on a captured terrestrial multimedia signal formatted for visual reproduction or audible reproduction on the computer system device. In an alternate embodiment, the transferred signals may be transferred to another computer system for visual or audible reproduction thereon.

In one embodiment, the handheld device is operative to transfer multiple channels of demodulated and/or decoded multimedia signals to the computer device thereby allowing, for example, the display of two or more multimedia signals on the computer system display. In another embodiment, the multiple channels may include demodulated and/or decoded multimedia signals from one or more related or unrelated multimedia technology standards. In another embodiment, the handheld device I operative to parse or demultiplex audio and video components from the demodulated and or/decoded multimedia signals and transfer one or more of these component parts to the computer system. Other component parts may be reproduced or stored on the handheld device.

The present description also provides a method and apparatus for the receipt of one or more transferred signals from the handheld device and for the visual reproduction and/or audible reproduction of the one or more transferred signals on the computer system. The transferred signals may include handheld demodulated multimedia signals, handheld decoded multimedia signals and terrestrial demodulated multimedia signals formatted using one or more related or unrelated technology standards. In one embodiment, the transferred signals may include audio and/or video components of the signals listed above. When the transferred signals are demodulated but not yet decoded, the computer system's multimedia processor decodes the underlying audio and video information prior to reproduction thereof on the computer system display and/or at least one speaker. In one embodiment, the method and apparatus provide for the transfer of the transmitted signals to another computer system for visual or audible reproduction thereon.

Accordingly, the method and apparatus discussed herein allows for the reception of multimedia signals such as DVB-H and DVB-T signals by a handheld device for subsequent reproduction on the computer system or for transfer to another computer system.

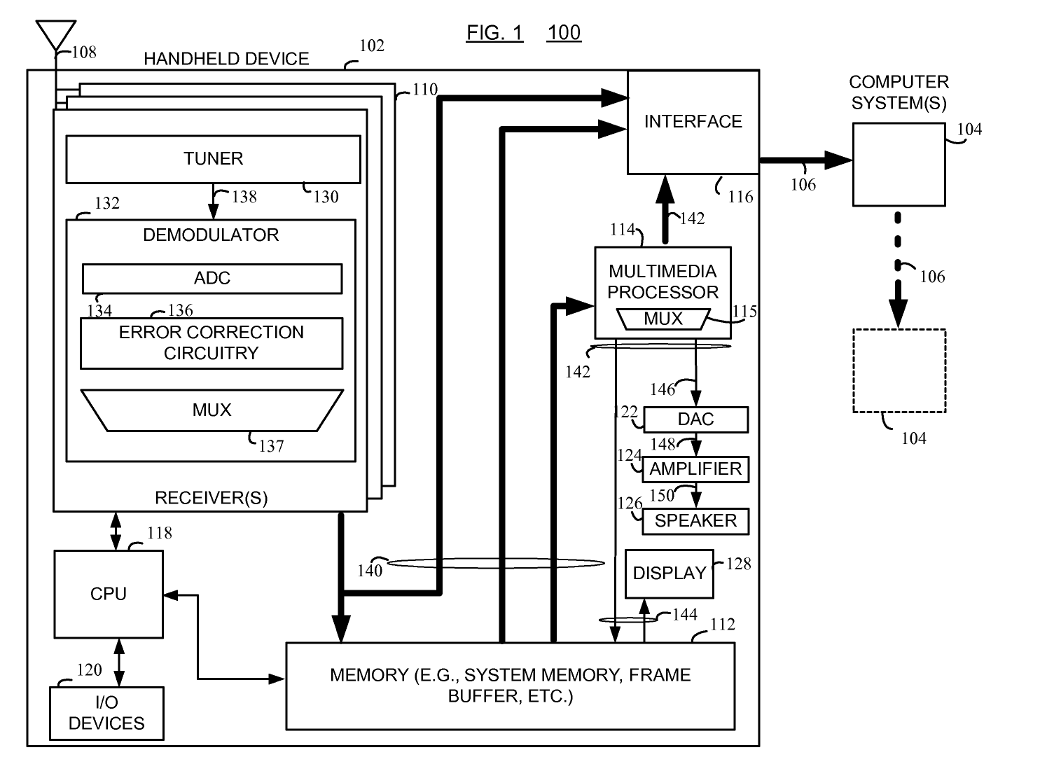

The present disclosure can be more fully described with reference to FIGS. 1-8. In the following detailed description, numerous specific details are set forth in order to provide a thorough understanding of the present disclosure. It will be apparent to one of ordinary skill in the art, however, that these specific details need not be used to practice the present embodiments of the disclosure. In other instances, well-known structures, interfaces, and processes have not been shown or have not been shown in detail in order not to unnecessarily obscure the present disclosure.

FIG. 1 is a block diagram illustrating one example of a system 100 including a handheld device 102 coupled to at least one computer system 104 via a connection 106 (e.g., a physical or wireless bus). The handheld device 102 may be any type of mobile device such as a mobile phone, PDA, music player, etc. In one embodiment, the handheld device 102 includes at least one receiver 110, at least one antenna 108 (illustrated as one antenna coupled to one or more receivers 110), at least one memory 112, a multimedia processor 114, an interface 116, a CPU 118, one or more input/output devices, 120, a digital to audio converter (“DAC”) 122, an amplifier 124, at least one handheld speaker 126 and a handheld display 128. As illustrated, each of the at least one receiver 110 includes a tuner 130 and a demodulator 132.

The tuner 130 is any suitable device capable of tuning to a desired radio frequency using the at least one antenna 108 and capturing signals from an external source (not shown) where the signals are broadcast at the tuned frequency. The desired radio frequency may be set using any suitable technique. In one example, a user inputs the desired frequency (or enters a command representing the desired frequency—e.g., a channel identifier) to which the tuner 130 should pass radio frequency waves. The user input may be entered on any suitable input/output device 120 such as, for example, a keyboard or touchpad. Thereafter and in accordance with known techniques, the tuner 130 captures at least handheld multimedia signals 138 and/or terrestrial multimedia signals 138 (individually or collectively, “broadcast multimedia signals” 138). As one having ordinary skill in the art will recognize, each of the broadcast multimedia signals 138 are modulated according to one of a plurality of known multimedia transmission standards (e.g., Digital Video Broadcast-Handheld, Digital Video Broadcast-Terrestrial, etc.) prior to transmission by the external source.

As used herein, handheld multimedia signals 138 are multimedia signals formatted for the visual reproduction of underlying video information and/or audible reproduction of underlying audio information on the handheld device, e.g., handheld device 102. In one embodiment, handheld multimedia signals 138 are Digital Video Broadcast-Handheld (“DVB-H”) signals. In another embodiment, handheld multimedia signals 108 correspond to a streaming channel broadcast over a carrier network by a service provider. Similarly, terrestrial multimedia signals 138 are multimedia signals formatted for the visual reproduction of underlying video information and/or audible reproduction of underlying audio information on an external computer system, e.g., computer system 104. In one embodiment, terrestrial multimedia signals 138 are Digital Video Broadcast-Terrestrial (“DVB-T”) signals. One having ordinary skill in the art will recognize that handheld multimedia signals 138 and terrestrial multimedia signals 138 are not limited to DVB-H and DVB-T signals and may be any broadcast video signal, audio signal or audio/video signal formatted for at least one of a handheld device or for a computer system. Other broadcast multimedia signals capable of being captured by the one or more receivers 110 include signals formatted using one of the following standards: T-DMB, S-DMB, ISDB-T segment 1, ISDB-T full segment, DVB-T2, ATSC, DSDPA, MBMS, eVDO, WiMAX, MediaFLO, etc.

It will be understood that the number of receivers, employed in the one or more receivers 110 may be a manufacturing design choice based on the type of broadcast multimedia signals the handheld device 102 is designed to capture. For instance, a single receiver may be used if the handheld device 102 is designed to capture only related broadcast multimedia signals. For example, if a user desires to only capture DVB-H and/or DVB-T broadcast multimedia signals, a single receiver may be used because both DVB-H and DVB-T are related broadcast multimedia signals formatted using a related multimedia technology standard (e.g., both are part of the DVB suite of standards). However, if the handheld device 102 is designed to capture broadcast multimedia signals formatted using unrelated multimedia technology standards, two or more receivers may be necessary. For example, if it is desired to capture at least one of DVB-H and DVB-T and at least one of T-DMB and S-DMB, two receivers may be necessary. The first receiver may be capable of capturing and demodulating the related DVB-type signals while the second receiver may be capable of capturing and demodulating the related DMB-type signals.

In an alternate embodiment, instead of having multiple receivers when capturing unrelated multimedia signals, the handheld device 102 may employ a single receiver 110 having two or more demodulators 132 where each of the demodulators 132 is only responsible for demodulating one set of related broadcast multimedia signals.

After capture, the tuner 130 passes the broadcast multimedia signals 138 to the demodulator 132, any suitable device that generates a demodulated multimedia signal 140 therefrom. Optionally, the demodulator 132 includes an analog to digital converter (“ADC”) 134 and error correction circuitry (“ECC”) 136. Although the ADC 134 and ECC 136 are illustrated as components of the demodulator 132, it is recognized that each of the ADC 134 and/or ECC 136 need not necessarily be component members of the demodulator 132, but may be stand alone components of the at least one receiver 110 or any other suitable device capable of communication with the receiver 110 and/or the tuner 130. Generally, the ADC 134 first converts the captured broadcast multimedia signal 138 into digital form using known sampling techniques prior to demodulation by demodulator 132. Prior to transfer from the receiver 110, the demodulated multimedia signals 140 undergo error correction by ECC 136.

In one embodiment, the demodulated multimedia signals 140 are transferred to the at least one memory 112 for storage therein. The at least one memory 112 may be any suitable volatile or non-volatile memory device or memory devices such as, but not limited to, system memory, frame buffer memory, flash memory, etc. In one embodiment, the at least one memory 112 is a random access memory. Thereafter, the demodulated multimedia signals 140 are transferred to the interface 116 or the multimedia processor 114 based on at least one of a user input and the type of broadcast multimedia signal 138 received by the tuner 130. If the demodulated multimedia signals 140 are transferred to the interface 116, the demodulated multimedia signals 140 are transferred over connection 106 to the at least one computer system 104. In one embodiment, the interface 116 is any suitable interface that supports for example, a dedicated physical connection and/or a wireless connection. Alternatively, if the demodulated signals 140 are transferred to the multimedia processor 114, the multimedia processor 114 generates decoded multimedia signals 142. As discussed below, in one embodiment, the route taken by the demodulated multimedia signals 140 is related to where the demodulated multimedia signals 140 will be displayed. Accordingly, suitable user input may be accepted at the one or more input/output deices 120 to control this process.

The multimedia processor 114 may correspond to any suitable programmable or dedicated processor, processing engine, hardware accelerator, or any suitable combination of programmable or dedicated processors, processing engines, and hardware accelerators. In response to the demodulated multimedia signals 140, the multimedia processor 114 generates decoded multimedia signals 142 by decoding the video information and audio information contained in the demodulated multimedia signals 140. The multimedia processor 114 may use any suitable compression-decompression (“codec”) standard such as, but not limited to, H.264 and VC-1 to decode the underlying video information. Similarly, the multimedia processor 114 may use any suitable codec standard such as, but not limited to, AAC and MP3 to decode the underlying audio information. Additionally, the multimedia processor 114 may also perform additional “error correction” (e.g., error resiliency) by correcting synchronization errors, bad frame errors, and bad packet errors associated with the demodulated multimedia signals.

As one of ordinary skill in the art will appreciate, the decoded multimedia signals 142 include decoded video information 144 and/or decoded audio information 146. The decoded video information 144 may be transferred to the at least one memory 112 for subsequent visual reproduction on the handheld display 128. Similarly, the decoded audio information 146 may be transferred to the DAC 146 where an analog audio signal 148 is generated. Based on the analog audio signal 148, the amplifier 124 generates an amplified analog audio signal 150 for subsequent audible reproduction on the at least one handheld speaker 126. As one having ordinary skill in the art will recognize, the DAC 122 and amplifier 124 may be interchanged such that the decoded audio information 146 is first amplified and then converted to digital form. Alternatively, the decoded multimedia signals 142 may be transferred to the interface 116 for transmission along connection 106 to the at least one computer system 104 for visual reproduction, on the at least one computer system 104, of the decoded video information 144 and/or for audible reproduction, on the at least one computer system 104, of the audio information 146.

As configured, the handheld device 102 further supports time-shifting of the broadcasted multimedia signals 138. In one embodiment, the demodulated (but still encoded) multimedia signals 140 are stored in the at least one memory 112 until a user desires “play back” of the stored demodulated multimedia signals 140. At that point, the demodulated multimedia signals 140 are read from the at least one memory 112 and transferred to the multimedia processor 114 for subsequent processing as described above. Alternatively, in another embodiment, the multimedia processor 142 first decodes the demodulated multimedia signals 140, as previously described, and then the decoded video information 144, the decoded audio information 146 (not specifically illustrated) or the decoded multimedia signals 142 (not specifically illustrated) is stored in the at least one memory 112 until a user desires “play back” of the stored signals. When playback is desired, the stored decoded video information 144, stored decoded audio information 146 or the stored decoded multimedia signals 142 are read from the at least one memory 112 such that the video information 144 is supplied to the handheld display 128 for visual reproduction and/or the audio information 146 is supplied (not specifically illustrated) to the DAC 122 for audio reproduction using the handheld speaker 126.

In an alternate embodiment, the at least one receiver 110 directly transfers the demodulated multimedia signals 140 to the interface 116 for immediate transfer to the computer system 104. This embodiment may be used to conserve power in the handheld device 102 by shifting all subsequent processing to the at least one computer system 104.

In one embodiment, each of the at least one receiver 110 may be implemented on a single integrated circuit. Similarly, the CPU 118, interfaces (not shown) associated with the at least one I/O devices 120, the at least one memory 112, the multimedia processor 114, the interface 116, the DAC 122, the amplifier 124 and the interfaces (not shown) associated with the at least one handheld speaker 126 and the handheld display 128 may be implemented on one or more different integrated circuits.

It will be recognized that in one embodiment, the handheld device 102 is not limited to mobile devices as previously described, but may include any suitable device or module capable of communication with computer system 104 and having at least an antenna 108, a tuner 130, a demodulator 132 and at least one memory 112.

In one embodiment, the handheld device 102 may inquire of the decoding capabilities of a computer system 104 and, based on the response, the handheld device 102 and its multimedia processor 114 may perform any necessary decoding of the demodulated multimedia signal 140. Any suitable technique may be used by the handheld device 102 to make the necessary inquiry of a computer system 104. Similarly, any suitable signal, flag or information may be submitted back to the handheld device 102 by the computer system 104 to indicate its decoding capabilities or abilities. For example, computer system 104 may not have the necessary codec or may have a less efficient or otherwise less desirable codec for performing the decoding of the broadcast multimedia signals 138 received by the handheld device 102 and thus the handheld device 102 may perform the necessary decoding of the demodulated multimedia signal 140 before transfer to the computer system 104.

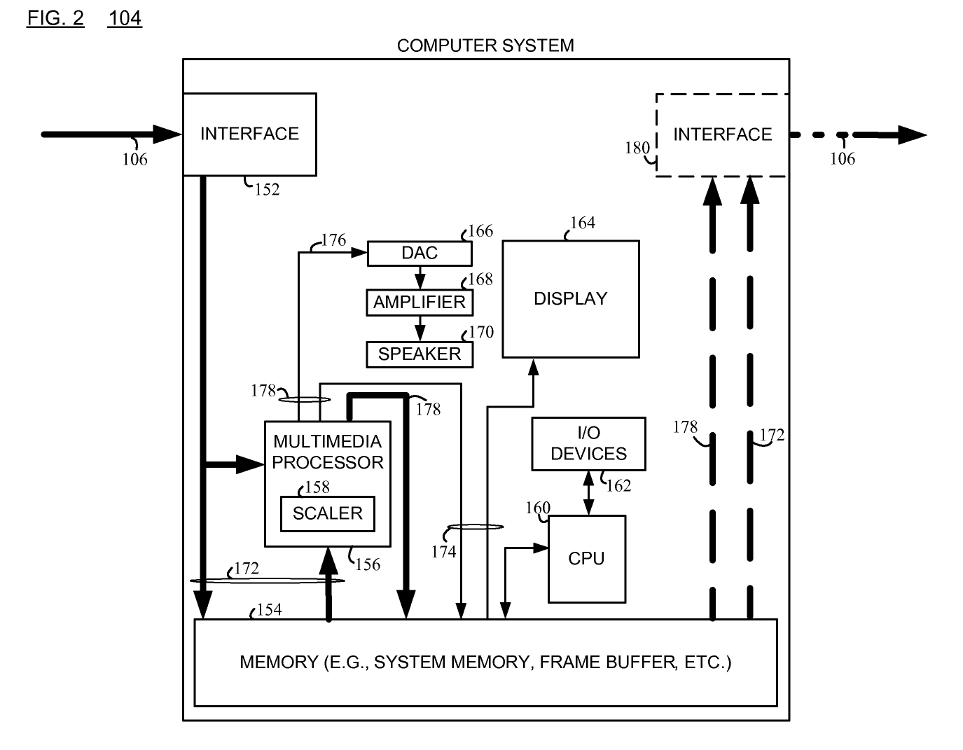

FIG. 2 is a block diagram illustrating one example of a computer system as illustrated in FIG. 1 in accordance with one embodiment of the present disclosure. Computer system 104 may be any suitable traditional computer system, a digital TV, high definition TV, a computer server, a projector, a hard drive, or any other suitable device or system having a suitable interface for receiving one or more transferred multimedia signals and having the ability to: (1) visually or audibly reproduce the transferred multimedia signals; and/or (2) transfer the transferred multimedia signals to another computer system for visual and/or audible reproduction thereon.

As illustrated, the computer system 104 of FIG. 2 includes a first interface 152, a at least one memory 154, a multimedia processor 156, a CPU 160, at least one input/output device 162, a display 164, a DAC 166, an amplifier 168, at least one speaker 170, and a second interface 180. In one embodiment: the first interface 152 and second interface 180 are any suitable interfaces that support, for example, a physical connection and/or a wireless connection 106 from handheld device 102 and another computer system 104, respectively. The at least one memory 154 may be any suitable volatile or non-volatile memory device or memory devices such as, but not limited to, system memory (e.g., random access memory), frame buffer memory, flash memory, etc. The multimedia processor 156 may correspond to any suitable programmable or dedicated processor, processing engine, hardware accelerator, or any suitable combination of programmable or dedicated processors, processing engines, and hardware accelerators.

As discussed above, the handheld device 102 is capable of transferring a variety of signals along connection 106 to interface 152. Depending on user input (e.g., input on the at least one input/output device 102) and the broadcast multimedia signals 138 captured, connection 106 transfers demodulated multimedia signals 140 and/or decoded multimedia signals 142 (collectively “transferred signals” 172). As one having ordinary skill in the art will recognize, the transferred signals 172 may correspond to terrestrial demodulated multimedia signals (e.g., where the receiver 110 captures terrestrial multimedia signals 138 and does not decode), handheld demodulated multimedia signals (e.g., where the receiver 110 captures handheld multimedia signals and does not decode) or handheld decoded multimedia signals (e.g., where the receiver 110 captures handheld multimedia signals and does decode) or any combination thereof (e.g., where connection 106 transfers multiple channels of transferred signals 172). Generally, it is not advantageous to pass terrestrial decoded multimedia signals because of the limited resources available to most handheld devices. However, one having ordinary skill in the art will recognize that the transferred signals 172 may include terrestrial decoded multimedia signals.

Upon receipt, the transferred signals 172 are transferred to the at least one memory 154 for storage or to the multimedia processor 156 based on user inputs and/or the type of transferred signals 172. When the transferred signals 172 correspond to handheld demodulated multimedia signals, the transferred signals 172 are transferred to the multimedia processor 156 (from the interface 152 or from the at least one memory 154) for processing. Similar to the handheld multimedia processor 114, the computer system multimedia processor 156 then generates computer system-generated handheld decoded multimedia signals using known techniques. When the transferred signals 172 correspond to terrestrial demodulated multimedia signals, the transferred signals 172 are transferred to the multimedia processor 156 (from the interface 152 or from the at least one memory 154) for processing. The multimedia processor 156 then generates computer system-generated terrestrial decoded multimedia signals also using known techniques.

As illustrated, the multimedia processor 156 may comprise a scaler 158 such as a hardware scaler or any other suitable dedicated or programmable device capable of scaling the resolution of underlying video information associated with one of the transferred signals 172 to meet the specifications, characteristics or capabilities of the computer system display 164. Alternatively, the scaler 158 is separate from the multimedia processor 156 but is in communication with at least the at least on memory 154 and/or multimedia processor 156. Thus, in one embodiment, multimedia processor 156 not only generates the computer system-generated handheld decoded multimedia signals and the computer system-generated terrestrial decoded multimedia signals, but also scales: the resolution of video information associated with these signals and the resolution of video information associated with the handheld or terrestrial decoded multimedia signals.

Similar to the decoded multimedia signals 142, each of the decoded transferred signals 178 (e.g., the computer-system generated handheld decoded multimedia signals, the handheld decoded multimedia signals, the computer system-generated terrestrial decoded multimedia signals and the terrestrial decoded multimedia signals) include underlying video information and audio information. As illustrated, multimedia processor 156 transfers the video information 174 associated with decoded transferred signals to the at least one memory 154 for storage and subsequent visual reproduction on computer system display 164. Similarly, multimedia processor 156 transfers the audio information associated with decoded transferred signals 176 to the DAC 166 for subsequent audible reproduction on the at least one computer system speaker 170.

One having ordinary skill in the art will also recognize that the decoded audio information 176 may be processed by DAC 166, amplifier 168 and the at least one computer system speaker 170 in the same manner as the decoded audio information 146 was processed by DAC 122, amplifier 124 and the at least one handheld speaker 126 of the handheld device 102.

As configured, the computer system 104 similarly supports time-shifting of the transferred signals 172 in the same manner as the handheld device 102 also supported time-shifting of the broadcasted multimedia signals 138. One having ordinary skill in the art will recognize that the handheld user and/or the computer system user may desire to “play back” stored transferred signals 172 and/or stored decoded transferred signals 178 using the at least one memory 154. User input may be accepted by the at least one input/output devices 120 and/or the at least one input/output devices 162 using known techniques to control the “play back” of the signals. If input is provided to the at least one input/output devices 120, one having ordinary skill in the art will recognize that any suitable indicator, flag, or data may be transferred along connection 106 with the transferred signals 172 such that the computer system 104 and multimedia processor 156 are suitably directed to time-shift the signals.

As illustrated, FIG. 2 also includes second interface 180 that may further transfer one of the transferred signals 172 or one of the decoded transferred signals 178 to another computer system 104 (FIG. 1). One having ordinary skill in the art will recognize that any suitable transfer mechanism may be used to allow user input at one or the input devices 120 and 160 (similar to the time-shifting feature explained above) to control whether a computer system 104 should reproduce the transferred signals 172, or transfer some form of the transferred signals 172 to another computer system 104. In this manner, assuming system 100 included handheld device 102, a first computer system 104 and a second computer system 104, the first computer system could act like a server computer system for distribution on the second computer system 104.

Although not illustrated, one having ordinary skill in the art will recognize that the transmission of signals among handheld device 102 components and among the computer system 104 components may be recognized under the control of the respective CPU (118, 160), the respective multimedia processor (114, 156), one or more direct memory access engines (not illustrated) or any combination therof. The physical transmissions may be recognized along any suitable connection, internal bus, communication link, or any suitable combination of connections, internal buses and communication links.

One having ordinary skill in the art will also recognize that in one embodiment, the interface 116 and the second interface 180 transfers multiple channels of transferred signals 172 or some combination of transferred signals 172 and decoded transferred signals 178. Correspondingly, interface 152 similarly receives multiple channels of transferred signals 172. The multiple channels allow the computer system display 164 to reproduce video information associated with more than one transferred signal at one time (e.g., using picture-in-picture technology). Similarly, one having ordinary skill in the art will recognize that the handheld device 128 is also configured to display more than one broadcast multimedia signal 138 at one time using similar technology.

Using the architecture of system 100 and computer system 104, it is recognized that many benefits may be realized. One feature realized is the ability of the handheld device 102 to receive both related and unrelated broadcast multimedia signals 138 and then to direct any combination of received related and unrelated broadcast multimedia signals 138 for storage and/or reproduction on any number of components and computer systems. With respect to FIG. 1, demodulator 132 is further equipped with demultiplexor 137 and the multimedia processor is further equipped with demultiplexor 115 controlled by CPU 118 and user input 120. Using the one or more of demultiplexors 137 and 115, a user of the handheld device 102 may direct audio and video components of the captured related and/or unrelated broadcast multimedia signals to one or more of the memory 112, interface 116 and multimedia processor 114 for suitable storage, reproduction and/or transmission to one or more of the at least one computer system 104. For example, if handheld device 102 captures a DVB-H, a DVB-T and a T-DMB signal by the at least one receiver 110, the user may direct the audio component of the demodulated DVB-H signal to memory 112 for subsequent reproduction on speaker 126. In this example, the user may direct the video component of the demodulated DVB-H signal to memory 112 for time-shifting and direct the entire demodulated T-DMB signal to the interface 116 for decoding and reproduction on one of the at least one computer systems 104. As one having ordinary skill in the art, the demultiplexors 137 and 115 operate to separate the video and audio components from a given multimedia signal thereby allowing for the above flexibility of handheld device 102.

It may further be appreciated that similar demultiplexors might exist in multimedia processor 156 of FIG. 2. Therefore, similar to the manner in which the handheld device 102 may transfer any combination of the audio and video components of multimedia signals 172 to computer system 104, the computer system 104 may similar transfer any combination of the audio and video components of multimedia signals 172, 178 to a second computer system.

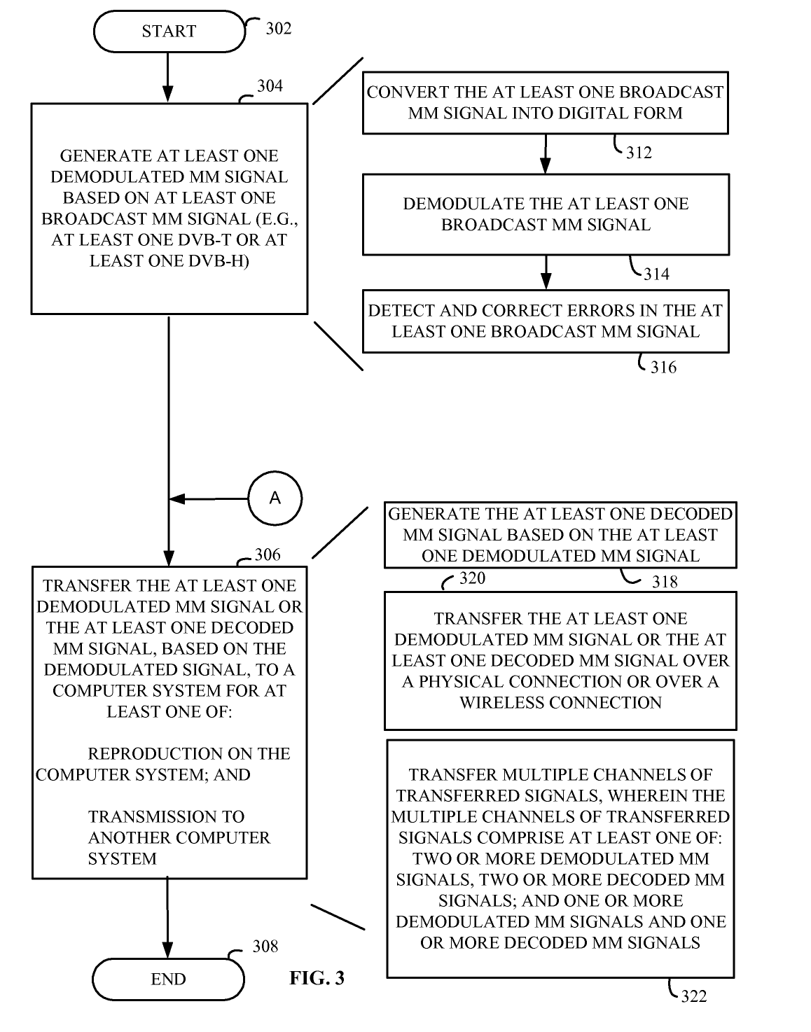

FIG. 3 is a flow chart illustrating one example of a method for transferring handheld multimedia signals for reproduction on the computer system or transmission to another computer system. The method starts with block 302 where, for example, at least one broadcast multimedia signal is captured by a receiver such as receiver 110 as illustrated in FIG. 1. The at least one broadcast multimedia signal is one of: at least one handheld (“HH”) multimedia (“MM”) signal formatted for at least one of: visual reproduction and audible reproduction on the handheld device (e.g., DVB-H) or at least one terrestrial multimedia signal formatted for at least one of: visual reproduction and audible reproduction on the computer system (e.g., DVB-T). The method continues with block 304 where at least one demodulated multimedia signal is generated based on the at least one broadcast multimedia signal. In one embodiment, method block 304 is implemented by method blocks 312-316 where: the at least one broadcast multimedia signal is converted into digital form (using e.g., ADC 134 of FIG. 1), the at least one broadcast multimedia signal is demodulated (using e.g., demodulator 132 of FIG. 1), and errors are detected and corrected in the at least one of broadcast multimedia signal (using e.g., ECC 136 of FIG. 1).

The method continues in block 306 where the at least one demodulated multimedia signal or at least one decoded multimedia signal, based on the demodulated multimedia signal, is transferred to a computer system for reproduction on the computer or transmission to another computer system. As illustrated, the method may include generating the at least one decoded multimedia signal based on the at least one demodulated multimedia signal as indicated in block 318. Transmission to the computer system may include, in one embodiment, transferring the at least one demodulated multimedia signal or the at least one decoded multimedia signal over a physical connection (such as a physical bus) or over a wireless connection (such as a wireless bus) as illustrated in block 320. Transmission to the computer system may also include method block 322 where multiple channels of transferred signals are transferred, wherein the multiple channels of transferred signals comprise at least one of: two or more demodulated multimedia signals; two or more decoded multimedia signals, and one or more demodulated multimedia signals and one or more decoded multimedia signals. The methods of blocks 306 and 318-222 may be implemented, in one embodiment, using at least the multimedia processor 114 and interface 116 of the handheld device 102, and connection 106. The method ends in block 308 where, for example, the computer system processes the transferred signals as described below.

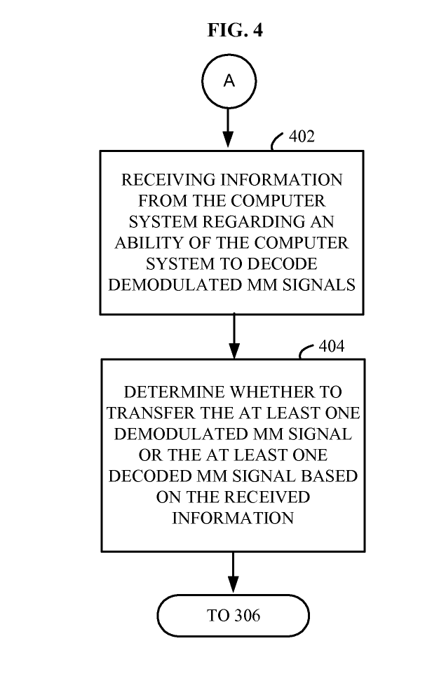

In one embodiment, the method of FIG. 3 includes the method of FIG. 4 which illustrates the manner in which the handheld device may, in one embodiment, determine which multimedia signals will be transferred to the computer system. The method begins at reference A (from block 304) and continues with block 404 where the handheld device receives information from the computer system regarding an ability of the computer system to decode demodulated multimedia signals. As explained above with reference to FIG. 1, this may be implemented using interface 116. In one embodiment, the handheld device 102 may inquire of the decoding capabilities of a computer system 104. Any suitable technique may be used by the handheld device 102 to make the necessary inquiry of a computer system 104. Similarly, any suitable signal, flag or information may be submitted back to the handheld device 102 by the computer system 104 to indicate its decoding capabilities or abilities. The method continues in block 404 wherein it is determined whether to transfer the at least one demodulated multimedia signal or at least one decoded multimedia signal based on the received information. In one embodiment, the handheld device 102 may inquire of the decoding capabilities of a computer system 104 and, based on the response, the handheld device 102 and its multimedia processor 114 may perform any necessary decoding of the demodulated multimedia signal 140. In one embodiment, the CPU 118 or the multimedia processor 114 make this determination. Although not specifically illustrated, any suitable communication path or link may be used to transfer the received information to one of the multimedia processor 114 and the central processing unit 118. The method continues in block 306 of FIG. 3.

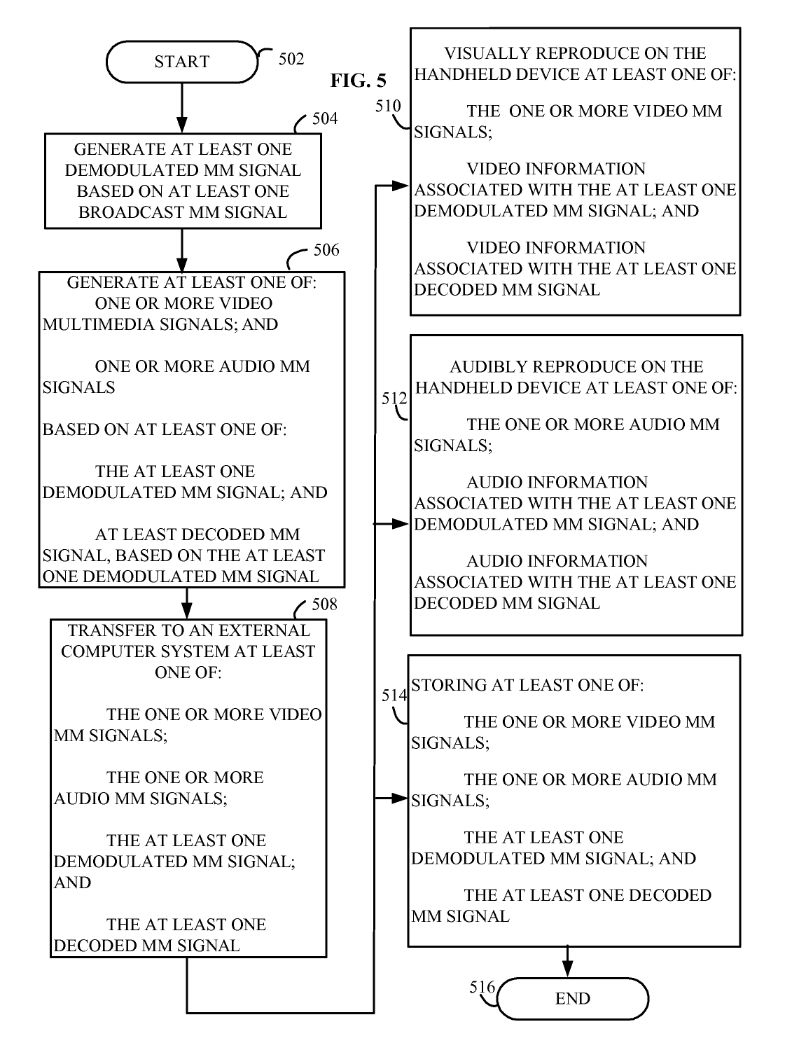

FIG. 5 is a flow chart illustrating one example for generating at least one demodulated multimedia signal and providing additional transmission, reproduction and storage capabilities in accordance with one embodiment of the present disclosure. The method begins with block 502 where, for example, at least one broadcast multimedia signal is captured by, for example, a receiver such as receiver 110 as illustrated in FIG. 1. In block 504, the method continues where at least one demodulated multimedia signal is generated based on the at least one broadcast multimedia signal. Block 504 may be implemented in the same or similar manner as block 304 of FIG. 3. The method then continues in block 506 where one or more video multimedia signals and/or one or more audio multimedia signals wherein the generated signals are generated based on one or more of the at least one demodulated multimedia signal and the at least one decoded multimedia signal. In one embodiment, the one or more video and audio multimedia signals may be generated using demultiplexor 137 or demultiplexor 115 of FIG. 1.

The method of FIG. 5 continues with block 508 and any combination of blocks 510-514. In blocks 508 and 514 at least one of: the one or more video multimedia signals, the one or more audio multimedia signals, the at least one demodulated multimedia signal, and the at least one decoded multimedia signal are transferred to an external computer system or stored. In one embodiment, this is performed using interface 116 under the direction of, CPU 118 and multimedia processor 114 or the at least one memory 112 of FIG. 1. In blocks 510 and 512, the video and/or audio information associated with the above signals may be reproduced using, for example, the techniques described with respect to FIG. 1. Lastly, the method ends in block 516 where, for example, any number of subsequent processing steps may be performed by the computer system or where the user may enjoy reproduction of multimedia signals on the handheld device.

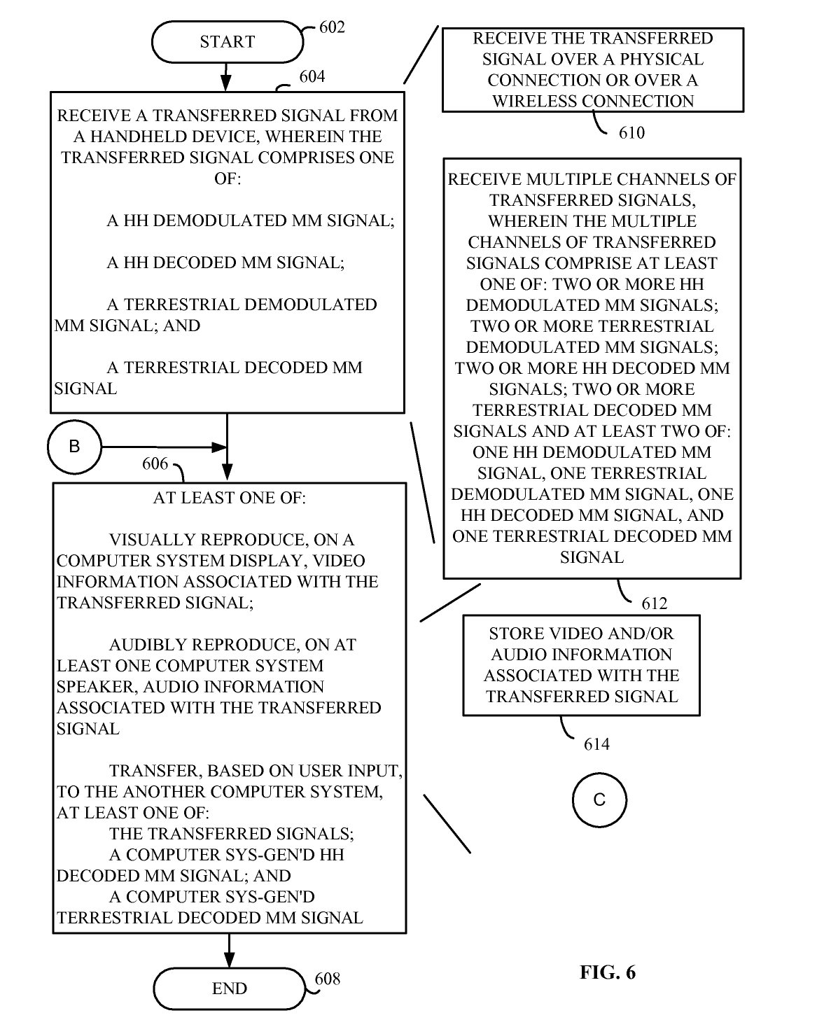

FIG. 6 is a flow chart illustrating one example for reproducing or transferring received multimedia signals from a handheld device in accordance with one embodiment of the present disclosure. The method begins in block 602 where, for example, transferred signals are sent by a handheld device similar to block 502 of FIG. 2. Next, in block 604, a transferred signal is received from the handheld device wherein the transferred signal comprises one of: a handheld demodulated multimedia signal; a handheld decoded multimedia signal; a terrestrial demodulated multimedia signal; and a terrestrial decoded multimedia signal. The handheld demodulated multimedia signal and the handheld decoded multimedia signal are formatted for at least one of: visual reproduction and audible reproduction on the handheld device (e.g., DVB-H) and the terrestrial demodulated multimedia signal and the terrestrial decoded multimedia signal are formatted for at least one of: visual reproduction and audible reproduction on the computer system (e.g., DVB-T).

In one embodiment, block 604 includes receiving the transferred signal over a physical connection or over a wireless connection as illustrated in block 610. In another embodiment, block 606 includes the method of block 612 where multiple channels of transferred signals are received. Multiple channels may comprise at least one of: two or more handheld demodulated multimedia signals; two or more terrestrial demodulated multimedia signals; two or more handheld decoded multimedia signals; and two or more terrestrial decoded multimedia signals; and at least two of: one handheld demodulated multimedia signal; one terrestrial demodulated multimedia signal; one handheld decoded multimedia signal; and one terrestrial decoded multimedia signal. The methods of blocks 604 and 610-612 may be implemented, in one embodiment, using connection 106 and interface 152 of FIG. 1.

Next, the method of FIG. 6 includes at least one of: visually reproducing, on a computer system display, video information associated with the transferred signal, audibly reproducing, on at least one computer system speaker, audio information associated with the transferred signal as illustrated in block 606, and transferring, based on user input, to another computer system at least one of the transferred signals, a computer system-generated handheld decoded multimedia signal and a computer system-generated terrestrial decoded multimedia signal. In one embodiment, the method of block 606 further includes the methods of block 614 where video information associated with the transferred signal is stored (e.g., for subsequent display of time-shifted video information) In one embodiment, the methods of blocks 606 and 614 may be implemented using at least the multimedia processor 156, the at least one memory 154, the display 164, the DAC 166, the amplifier 168 and the at least one speaker 170 of computer system 104 of FIG. 1. Lastly, the method ends in block 608 where the user may enjoy the reproduced transferred signals on the computer system.

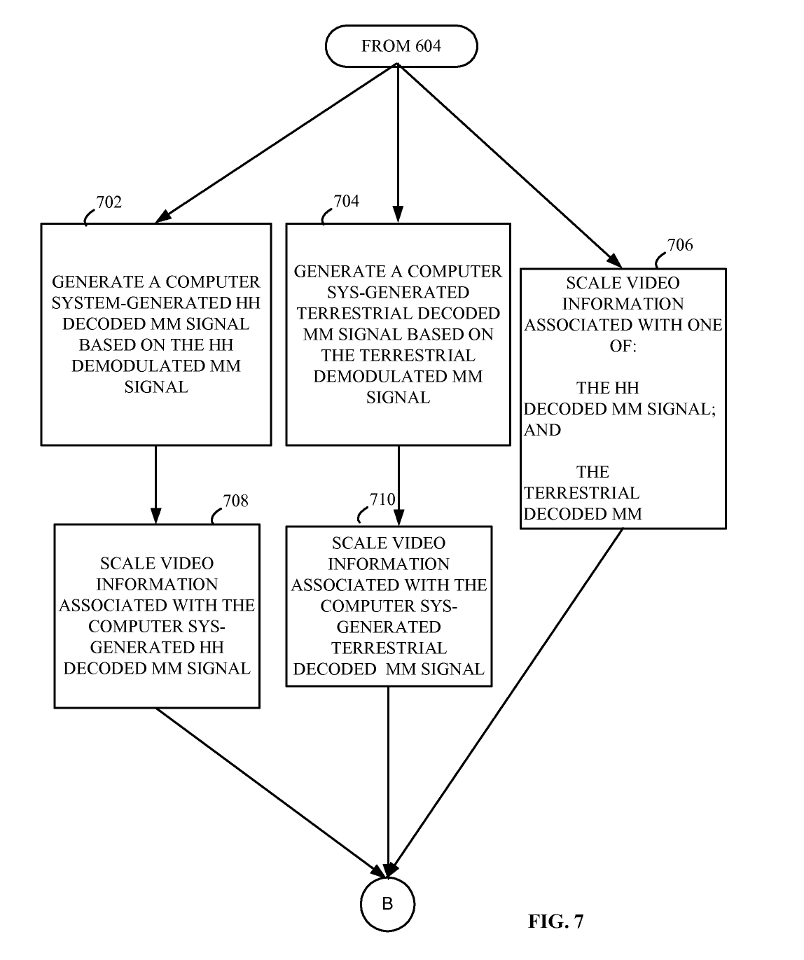

FIG. 7 illustrates one example for generating a computer system-generated handheld decoded multimedia signal and a computer system-generated terrestrial decoded multimedia signal, and scaling decoded signals for visual display on computer system in accordance with one embodiment of the present disclosure. As illustrated, the method begins from block 604 and continues with one of blocks 702-706. As explained in the art, the method may continue based on user input on, for example, input device 162. In block 702, a computer system-generated handheld decoded multimedia signal is generated based on the handheld demodulated multimedia signal. In block 704, a computer system-generated terrestrial decoded multimedia signal is generated based on the terrestrial demodulated multimedia signal. Either of block 702 and block 704 may be implemented using, for example, multimedia processor 156. In blocks 706-708, video information associated with a respective one of: the handheld decoded multimedia signal, the terrestrial decoded multimedia signal, the computer system-generated handheld decoded multimedia signal and the a computer system-generated terrestrial decoded multimedia signal is scaled. In one embodiment, blocks 706-708 may be scaled for suitable display on computer system display 164 by, for example, scaler 158. The method continues with block 606 of FIG. 6 as illustrated by reference B.

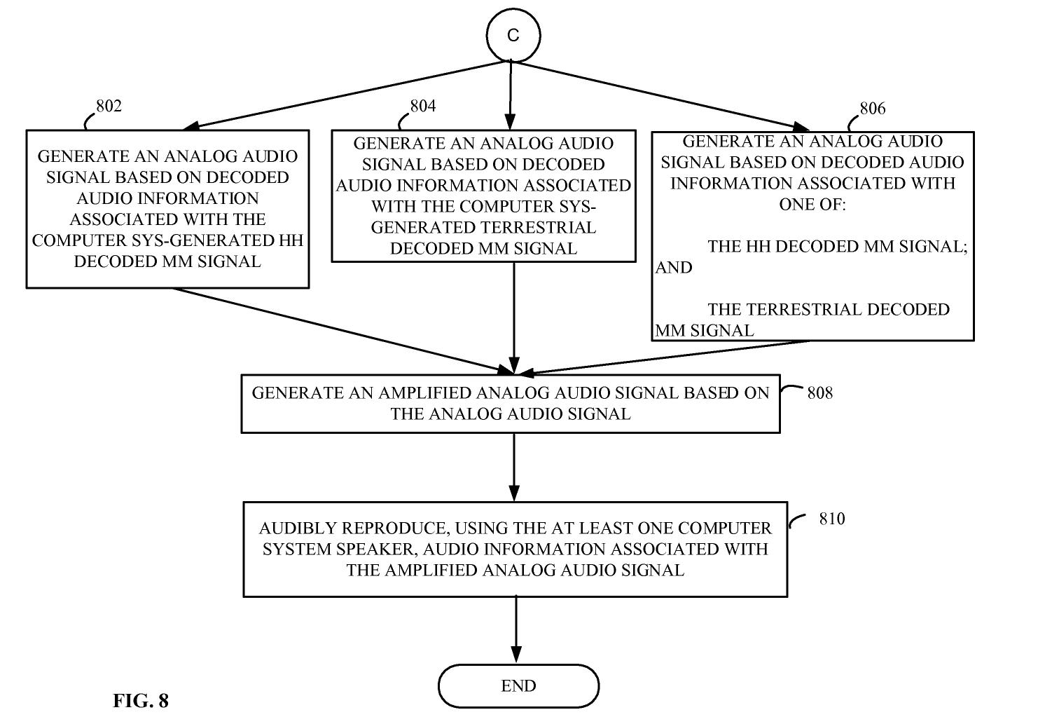

FIG. 8 illustrates one method of audibly reproducing, on at least one computer system speaker, audio information associated with the transferred signal, in accordance with one embodiment of the present disclosure. The method begins after block 604 or after completion of method blocks associated with reference B. As illustrated, at least one of blocks 802-806 may follow. In each of blocks 802-806, an analog audio signal is generated. In block 802, the analog audio signal is generated based on audio information associated with the computer system-generated handheld decoded multimedia signal. In block 804, the analog audio signal is generated based on audio information associated with the computer system-generated terrestrial decoded multimedia signal. In block 806, the analog audio signal is generated based on audio information associated with the handheld decoded multimedia signal or the terrestrial decoded multimedia signal. In one embodiment, the analog audio signal is generated using digital to analog converter 166 (and possibly a demultiplexor—not shown—associated with multimedia processor 156).

The method of FIG. 8 continues with block 808 where an amplified analog audio signal is generated based on the analog audio signal previously generated in one of blocks 802-806. In one embodiment, the amplified analog audio signal is generated using amplifier 168. In block 810, audio information associated with the amplified analog audio signal is audibly reproduced using the at least one computer system speaker (e.g., speaker 170). The method concludes in the same manner as in FIG. 6.

Thus, a method and apparatus has been disclosed that addresses the above needs of the prior art. Specifically, a handheld device and computer system have been described such that handheld multimedia signals may be transferred from the handheld device to the computer system for subsequent display and audible reproduction. As explained, the handheld transferred signals may correspond to handheld demodulated or decoded multimedia signals or terrestrial demodulated or decoded multimedia signals. The decision to send a particular type of multimedia signal to the computer system may be influenced by the decoding capability of the computer system and user input. For instance, one having ordinary skill in the art will recognize that based on the type of resources available on both the handheld device 102 and the computer system 104, the multimedia processor 156 may be better suited to decode the demodulated multimedia signal 140 using more advanced hardware accelerators, processors, or engines. Alternatively, the handheld device user may elect to visually reproduce and/or audibly reproduce the received signals using the handheld device resources (i.e., display and speakers) thereby providing greater flexibility for the handheld device user.

Among other advantages, the above method and apparatus enables a handheld device to receive handheld multimedia signals formatted for visual and audible reproduction on a handheld device and, through for example user input, display the multimedia signals on the handheld device or on a computer system. In one embodiment, this permits a user to take advantage of better computer system display and speakers and better decoding engines/algorithms. The apparatus and method further enables a handheld device to receive terrestrial multimedia signals formatted for visual and audible reproduction on a computer system and, through for example user input, display the multimedia signals on the computer system. In one embodiment, this permits a user to use a handheld to tune and demodulate the terrestrial multimedia signals when a computer system receiver is either unavailable or busy processing other signals. Other advantages will be recognized by one of ordinary skill in the art.

It will also be recognized that the above description describes mere examples and that other embodiments are envisioned and covered by the appended claims. For example, it is recognized that one or more components of the handheld device 102 and the computer system 104 (e.g., multimedia processor 114, 156) may be implemented in software (i.e., as stored instructions) and executed by at least one of CPU 118 and CPU 160, respectively. It will further be recognized that certain components such as, for example, amplifiers 124, 168 and error correction circuitry 136 illustrated in FIG. 1 are optional. It is therefore contemplated that the present invention cover any and all modifications, variations or equivalents that fall within the spirit and scope of the basic underlying principles disclosed above and claimed herein.

What is claimed is:

1. A handheld device comprising:
at least one receiver operative to generate at least one demodulated multimedia signal based on at least one broadcast multimedia signal; and
an interface operative to transfer the at least one demodulated multimedia signal or at least one decoded multimedia signal, based on the at least one demodulated multimedia signal, to a computer system, external to the handheld device, for at least one of: reproduction on the at least one computer system and transmission to another computer system.

2. The handheld device of claim 1, further comprising a multimedia processor operative to generate the at least one decoded multimedia signal based on the at least one demodulated multimedia signal.

3. The handheld device of claim 1, wherein the at least one broadcast multimedia signal is one of:
at least one handheld multimedia signal formatted for at least one of: visual reproduction and audible reproduction on the handheld device; and
at least one terrestrial multimedia signal formatted for at least one of: visual reproduction and audible reproduction on the computer system.

4. The handheld device of claim 3, wherein the at least one handheld multimedia signal is at least one Digital Video Broadcasting-Handheld (DVB-H) signal and wherein the at least one terrestrial multimedia signal is at least one Digital Video Broadcasting-Terrestrial (DVB-T) signal.

5. The handheld device of claim 1, wherein the at least one receiver comprises:
a tuner operative to capture the at least one broadcast multimedia signal;
a demodulator comprising an analog to digital converter and error correction circuitry wherein the demodulator is operative to demodulate the at least one broadcast multimedia signal, thereby generating the at least one demodulated multimedia signal; and
wherein the analog to digital converter is operative to convert the at least one broadcast multimedia signal into digital form and wherein the error correction circuitry operative to detect and correct errors in the at least one demodulated multimedia signal.

6. The handheld device of claim 1, wherein the interface is physically or wirelessly coupled to the computer system.

7. The handheld device of claim 6, wherein the interface is operative to transfer multiple channels of transferred signals, wherein the multiple channels of transferred signals comprise at least one of: two or more demodulated multimedia signals, two or more decoded multimedia signals; and one or more demodulated multimedia signals and one or more decoded multimedia signals.

8. The handheld device of claim 1, wherein:
the interface is operative to receive information from the computer system regarding an ability of the computer system to decode the demodulated multimedia signals; and
at least one of a multimedia processor associated with the handheld device or central processing unit associated with the handheld device is operative to determine whether to transfer to the computer system the at least one demodulated multimedia signal or the at least one decoded multimedia signal based on the received information.

9. The handheld device of claim 1, wherein reproduction on the computer system comprises at least one of: visual reproduction of video information associated with the at least one broadcast multimedia signal and audible reproduction of audio information associated with the at least one broadcast multimedia signal.

10. The handheld device of claim 1, wherein each of the at least one receiver is operative to receive broadcast multimedia signals of a related multimedia technology standard.

11. The handheld device of claim 1, wherein the at least one receiver is operative to transfer the at least one demodulated multimedia signal to the interface for transfer to the computer system without storage in at least one memory.

12. A handheld device comprising:
at least one receiver operative to generate at least one demodulated multimedia signal based on at least one broadcast multimedia signal;
a demultiplexor operative receive and demultiplex, based on user input, at least one of:
the at least one demodulated multimedia signal; and
at least one decoded multimedia signal, based on the at least one demodulated multimedia signal;
wherein the demultiplexor is further operative to generate at least one of one or more video multimedia signals and one or more audio multimedia signals; and
an interface operatively coupled to an external computer system wherein the interface is operative to transfer at least one of:
the one or more video multimedia signals;
the one or more audio multimedia signals to the computer system;
the at least one demodulated multimedia signal; and
the at least one decoded multimedia signal.

13. The handheld device of claim 12, further comprising at least one of a display such that the display is operative to visually reproduce at least one of:
the one or more video multimedia signals;
video information associated with the at least one demodulated multimedia signal; and
video information associated with the at least one decoded multimedia signal.

14. The handheld device of claim 12, further comprising at least one speaker such that the at least one speaker is operative to audibly reproduce at least one of:
the one or more audio multimedia signals;
audio information associated with the at least one demodulated multimedia signal; and
audio information associated with the at least one decoded multimedia signal.

15. The handheld device of claim 12, further comprising:
at least one memory wherein the at least one memory is operative to store at least one of:
the one or more video multimedia signals;
the one or more audio multimedia signals;
the at least one demodulated multimedia signal; and
the at least one decoded multimedia signal.

16. A method for using a handheld device in communication with a computer system, external to the handheld device, the method comprising:
generating at least one demodulated multimedia signal based on at least one broadcast multimedia signal; and
transferring the at least one demodulated multimedia signal or at least one decoded multimedia signal, based on the at least demodulated signal, to the computer system for at least one of: reproduction on the computer system and transmission to another computer system.

17. The method of claim 16, further comprising generating the at least one decoded multimedia signal based on the at least one demodulated multimedia signal.

18. The method of claim 16, wherein the at least one broadcast multimedia signal is at least one of:
at least one handheld multimedia signal formatted for at least one of: visual reproduction and audible reproduction on the handheld device; and
at least one terrestrial multimedia signal formatted for at least one of: visual reproduction and audible reproduction on the computer system.

19. The method of claim 18, wherein the at least one handheld multimedia signal is at least one Digital Video Broadcasting-Handheld (DVB-H) signal and wherein the at least one terrestrial multimedia signal is at least one Digital Video Broadcasting-Terrestrial (DVB-T) signal.

20. The method of claim 16, wherein the method further comprises:
capturing the at least one broadcast multimedia signal; and
wherein generating the at least one demodulated multimedia signal comprises:
converting the at least one broadcast multimedia signal into digital form;
demodulating the at least one broadcast multimedia signal; and
detecting and correcting errors in the at least one broadcast multimedia signal.

21. The method of claim 16, wherein transferring the at least one demodulated multimedia signal or the at least one decoded multimedia signal comprises transferring the at least one demodulated multimedia signal or the at least one decoded multimedia signal over a physical connection or over a wireless connection.

22. The method of claim 21, wherein transferring the at least one demodulated multimedia signal or the at least one decoded multimedia signal comprises transferring multiple channels of transferred signals, wherein the multiple channels of transferred signals comprise at least one of: two or more demodulated multimedia signals, two or more decoded multimedia signals; and one or more demodulated multimedia signals and one or more decoded multimedia signals.

23. The method of claim 16, further comprising:
receiving information from the computer system regarding an ability of the computer system to decode demodulated multimedia signals; and
determining whether to transfer the at least one demodulated multimedia signal or the at least one decoded multimedia signal based on the received information.

24. The method of claim 16, wherein reproduction on the computer system comprises at least one of: visual reproduction of video information associated with the at least one broadcast multimedia signal and audible reproduction of audio information associated with at least one broadcast multimedia signal.

25. The method of claim 16, wherein, after generation of the at least one demodulated multimedia signal, the at least one demodulated multimedia signal is transferred to the computer system without storage in at least one memory.

26. A method for using a handheld device in communication with a computer system, external to the handheld device, the method comprising:
generating at least one demodulated multimedia signal based on at least one broadcast multimedia signal;
generating at least one of: one or more video multimedia signals and one or more audio multimedia signals based on at least one of:
the at least one demodulated multimedia signal; and
at least one decoded multimedia signal, based on the at least one demodulated multimedia signal; and
transferring to the computer system at least one of:
the one or more video multimedia signals;
the one or more audio multimedia signals;
the at least one demodulated multimedia signal; and
the at least one decoded multimedia signal.

27. The method of claim 26 further comprising visually reproducing on the handheld device at least one of:
the one or more video multimedia signals;
video information associated with at least one demodulated multimedia signal; and
video information associated with at least one decoded multimedia signal.

28. The method of claim 26 further comprising audibly reproducing on the handheld device at least one of:
the one or more audio multimedia signals;
audio information associated with at least one demodulated multimedia signal; and
audio information associated with at least one decoded multimedia signal.

29. The method of claim 26, further comprising storing at least one of:
the one or more video multimedia signals;
the one or more audio multimedia signals;
the at least one demodulated multimedia signal; and
the at least one decoded multimedia signal.

30. A computer system comprising:
an interface operative to receive a transferred signal from a handheld device external to the computer system, wherein the transferred signal comprises one of:
a handheld demodulated multimedia signal;
a handheld decoded multimedia signal;
a terrestrial demodulated multimedia signal; and
a terrestrial decoded multimedia signal.
wherein the handheld demodulated multimedia signal and the handheld decoded multimedia signal are formatted for at least one of: visual reproduction and audible reproduction on the handheld device and wherein the terrestrial demodulated multimedia signal and the terrestrial decoded multimedia signal are formatted for at least one of: visual reproduction and audible reproduction on the computer system or another computer system.

31. The computer system of claim 30, further comprising at least one of:
a display operative to visually reproduce video information associated with the transferred signal;
at least one speaker operative to audibly reproduce audio information associated with the transferred signal; and
at least one interface operative to transfer, based on user input, to the another computer system at least one of:
a handheld demodulated multimedia signal;
a handheld decoded multimedia signal;
a terrestrial demodulated multimedia signal;
a terrestrial decoded multimedia signal;
a computer system-generated handheld decoded multimedia signal based on the handheld demodulated multimedia signal; and
a computer system-generated terrestrial decoded multimedia signal based on the terrestrial demodulated multimedia signal.

32. The computer system of claim 30, wherein:
the handheld demodulated multimedia signal is a demodulated Digital Video Broadcast-Handheld (DVB-H) signal;
the handheld decoded multimedia signal is a decoded Digital Video Broadcast-Handheld (DVB-H) signal;
the terrestrial demodulated multimedia signal is a demodulated Digital Video Broadcast-Terrestrial (DVB-T) signal; and
the terrestrial decoded multimedia signal is a decoded Digital Video Broadcast-Terrestrial (DVB-T) signal.

33. The computer system of claim 30, further comprising a multimedia processor, wherein:
when the transferred signal is the handheld demodulated multimedia signal, the multimedia processor is operative to generate a computer system-generated handheld decoded multimedia signal based on the handheld demodulated multimedia signal; and
when the transferred signal is the terrestrial demodulated multimedia signal, the multimedia processor is operative to generate a computer system-generated terrestrial decoded multimedia signal based on the terrestrial demodulated multimedia signal.

34. The computer system of claim 32, wherein the multimedia processor includes a scaler operative to scale video information associated with:
a computer system-generated handheld decoded multimedia signal for visual reproduction on the display when the transferred signal is the handheld demodulated multimedia signal;
a computer system-generated terrestrial decoded multimedia signal for visual reproduction on the display when the transferred signal is the terrestrial demodulated multimedia signal;
the handheld decoded multimedia signal for visual reproduction on the display when the transferred signal is the handheld decoded multimedia signal; and
the terrestrial decoded multimedia signal for visual reproduction on the display when the transferred signal is the terrestrial decoded multimedia signal.

35. The computer system of claim 32, further comprising:
a digital to audio converter operative to generate an analog audio signal based on decoded audio information associated with:
a computer system-generated handheld decoded multimedia signal when the transferred signal is the handheld demodulated multimedia signal; and
a computer system-generated terrestrial decoded multimedia signal when the transferred signal is the terrestrial demodulated multimedia signal;
the handheld decoded multimedia signal when the transferred signal is the handheld decoded multimedia signal; and
the terrestrial decoded multimedia signal when the transferred signal is the terrestrial decoded multimedia signal; and
wherein the at least one speaker is operative to audibly reproduce audio information associated with the analog audio signal.

36. The computer system of claim 30, wherein the interface is physically or wirelessly coupled to a handheld device, external to the computer system, via a bus.

37. The computer system of claim 30, wherein the interface is operative to receive multiple channels of transferred signals, wherein the multiple channels of transferred signals comprise at least one of:
two or more handheld demodulated multimedia signals;
two or more terrestrial demodulated multimedia signals;
two or more handheld decoded multimedia signals;
two or more terrestrial decoded multimedia signals; and
at least two of:
one handheld demodulated multimedia signal, one terrestrial demodulated multimedia signal, one handheld decoded multimedia signal, and one terrestrial decoded multimedia signal.

38. The computer system of claim 30, further comprising at least one memory operative to store at least the video information associated with the transferred signal such that the display is operative to visually reproduce time-shifted video information associated with the stored video information.

39. The computer system of claim 30, further comprising:
at least one memory operative to store at least the video information associated with:
the computer system-generated handheld decoded multimedia signal when the transferred signal is the handheld demodulated multimedia signal; and
the computer system-generated terrestrial decoded multimedia signal when the transferred signal is the terrestrial demodulated multimedia signal,
such that the display is operative to visually reproduce time-shifted video information associated with the stored video information.

40. The computer system of claim 30, wherein each of the handheld demodulated multimedia signal, the handheld decoded multimedia signal, the terrestrial demodulated multimedia signal and the terrestrial decoded multimedia signal comprise at least one of: video information and audio information.

41. A method for using a computer system in communication with a handheld device external to the computer system, the method comprising:
receiving a transferred signal from the handheld device, wherein the transferred signal comprises one of:
a handheld demodulated multimedia signal;
a handheld decoded multimedia signal;
a terrestrial demodulated multimedia signal; and
a terrestrial decoded multimedia signal; and
wherein the handheld demodulated multimedia signal and the handheld decoded multimedia signal are formatted for at least one of: visual reproduction and audible reproduction on the handheld device and wherein the terrestrial demodulated multimedia signal and the terrestrial decoded multimedia signal formatted for at least one of: visual reproduction and audible reproduction on the computer system or another computer system.

42. The method of claim 41, further comprising at least one of:
visually reproducing, on a computer system display, video information associated with the transferred signal;
audibly reproducing, on at least one computer system speaker, audio information associated with the transferred signal; and
transferring, based on user input, to the another computer system, at least one of:
a handheld demodulated multimedia signal;
a handheld decoded multimedia signal;
a terrestrial demodulated multimedia signal;
a terrestrial decoded multimedia signal;
a computer system-generated handheld decoded multimedia signal based on the handheld demodulated multimedia signal; and
a computer system-generated terrestrial decoded multimedia signal based on the terrestrial demodulated multimedia signal.

43. The method of claim 41, wherein:
the handheld demodulated multimedia signal is a demodulated Digital Video Broadcast-Handheld (DVB-H) signal;
the handheld decoded multimedia signal is a decoded Digital Video Broadcast-Handheld (DVB-H) signal;
the terrestrial demodulated multimedia signal is a demodulated Digital Video Broadcast-Terrestrial (DVB-T) signal; and
the terrestrial decoded multimedia signal is a decoded Digital Video Broadcast-Terrestrial (DVB-T) signal.

44. The method of claim 41, further comprising:
generating a computer system-generated handheld decoded multimedia signal based on the handheld demodulated multimedia signal when the transferred signal is the handheld demodulated multimedia signal; and
generating a computer system-generated terrestrial decoded multimedia signal based on the terrestrial demodulated multimedia signal when the transferred signal is the terrestrial demodulated multimedia signal.

45. The method of claim 41, further comprising scaling video information associated with:
a computer system-generated handheld decoded multimedia signal for visual reproduction on the computer system display when the transferred signal is the handheld demodulated multimedia signal;
a computer system-generated terrestrial decoded multimedia signal for visual reproduction on the computer system display when the transferred signal is the terrestrial demodulated multimedia signal;
the handheld decoded multimedia signal for visual reproduction on the computer system display when the transferred signal is the handheld decoded multimedia signal; and
the terrestrial decoded multimedia signal for visual reproduction on the computer system display when the transferred signal is the terrestrial decoded multimedia signal.

46. The method of claim 41 further comprising:
generating an analog audio signal based on the decoded audio information associated with:
a computer system-generated handheld decoded multimedia signal when the transferred signal is the handheld demodulated multimedia signal;
a computer system-generated terrestrial decoded multimedia signal when the transferred signal is the terrestrial demodulated multimedia signal;
the handheld decoded multimedia signal when the transferred signal is the handheld decoded multimedia signal; and
the terrestrial decoded multimedia signal when the transferred signal is the terrestrial decoded multimedia signal; and
audibly reproducing, using the at least one computer system speaker, audio information associated with the analog audio signal.

47. The method of claim 41 wherein receiving a transferred signal comprises receiving the transferred signal over a physical connection or over a wireless connection.

48. The method of claim 41, wherein receiving a transferred signal comprises receiving multiple channels of transferred signals, wherein the multiple channels of transferred signals comprise at least one of:
two or more handheld demodulated multimedia signals;
two or more terrestrial demodulated multimedia signals;
two or more handheld decoded multimedia signals;
two or more terrestrial decoded multimedia signals; and
at least two of:
one handheld demodulated multimedia signal, one terrestrial demodulated multimedia signal, one handheld decoded multimedia signal and one terrestrial decoded multimedia signal.

49. The method of claim 41, further comprising:
storing at least video information associated with at least one of:
the handheld demodulated multimedia signal;
the handheld decoded multimedia signal;
the terrestrial demodulated multimedia signal;
the terrestrial decoded multimedia signal;
a computer system-generated handheld decoded multimedia signal based on the handheld demodulated multimedia signal;
a computer system-generated terrestrial decoded multimedia signal based on the terrestrial demodulated multimedia signal;
and visually reproducing, on the computer system display, time-shifted stored video information

50. The method of claim 41, wherein each of the handheld demodulated multimedia signal, the handheld decoded multimedia signal, the terrestrial demodulated multimedia signal and the terrestrial decoded multimedia signal comprise at least one of: video information and audio information.

51. A system comprising:
a handheld device operative to transfer a demodulated multimedia signal or a decoded multimedia signal based on a broadcast multimedia signal; and
a computer system, external to the handheld device, operative to receive the transferred demodulated multimedia signal or the transferred decoded multimedia signal for at least one of:
visual reproduction, on the computer system, of video information associated with the handheld multimedia signal;
audible reproduction, on the computer system, of audio information associated with the handheld multimedia signal;
transferring the transferred demodulated multimedia signal to another computer system; and
transferring the transferred decoded multimedia signal to the another computer system.

52. The system of claim 51 wherein the broadcast multimedia signal is a Digital Video Broadcasting-Handheld (DVB-H) signal or a Digital Video Broadcasting-Terrestrial (DVB-T) signal.
